(19) United States
(12) Patent Application Publication
(10) Pub. No.: US 2026/0294060 A1
(43) Pub. Date: Oct. 1, 2026

(54) TRACKING USER COMPLIANCE WITH A WEAR SCHEDULE FOR WEARING ONE OR MORE OPHTHALMIC DEVICES

(71) Applicant: Verily Life Sciences LLC, Dallas, TX (US)

(72) Inventors: Supriyo Sinha, South San Francisco, CA (US); Timothy Stowe, South San Francisco, CA (US); Christian Gutierrez, South San Francisco, CA (US)

(21) Appl. No.: 19/483,181

(22) PCT Filed: May 8, 2024
(86) PCT No.: PCT/US2024/028336

§ 371 Date: Nov. 10, 2025

Related U.S. Application Data
(60) Provisional application No. 63/465,431, filed on May 10, 2023.

(51) Int. Cl. A45C 11/00; G01S 17/04

(52) U.S. Cl. CPC A45C 11/005; G01S 17/04

(57) ABSTRACT

A case can be used to determine a presence or absence of an ophthalmic device to help determine user compliance to a wear schedule for the ophthalmic device. The case can include at least one storage well comprising a storage position for an ophthalmic device, a light source configured to generate light and direct the light into the storage well, and a detector configured to detect reflected light from within the storage well. The case can also include a microprocessor coupled to the light source and the detector and configured to: activate the light source to send a pulse of the light toward the storage position, and receive data related to the reflected light of the pulse of the light from the detector. The presence or absence of the ophthalmic device in the storage position can be determined based on the data related to the reflected light.

### CROSS-REFERENCES TO RELATED APPLICATIONS

The present application is a national phase application of Patent Cooperation Treaty (PCT) Application No. PCT/US2024/028336, filed May 9, 2024, which claims the benefit of and priority to U.S. Provisional Patent Application No. 63/465,431, filed May 10, 2023, the entirety of which are hereby incorporated by reference.

### TECHNICAL FIELD

The present disclosure relates generally to tracking user compliance with a specific wear schedule for wearing one or more ophthalmic devices, and more specifically, to tracking a presence of the one or more ophthalmic devices in a case (e.g., a contact lens case) and providing information about when and for how long the user is wearing the ophthalmic device to determine the user's compliance with the specific wear schedule.

### BACKGROUND

Ophthalmic devices (e.g., contact lenses) are commonly used for vision correction, eye shaping, drug delivery, protecting portions of the eye, personal ornamentation, or the like. It is often important that users of these ophthalmic devices adhere to a specific wear schedule; however, many users can be lax about following the specific wear schedule (for a variety of reasons). For example, an ophthalmic device used for drug delivery must be worn as instructed (e.g., at least during any drug delivery periods) to receive the desired treatment and/or health effect. Currently, there is no simple, inexpensive, and/or effective way to track a user's compliance with a specific wear schedule and medical professionals attempting to determine if a treatment with the ophthalmic device is or is not working are relegated to believing the user's word regarding compliance rather than data driven information.

### SUMMARY

The present disclosure provides a simple and inexpensive way to monitor a user's compliance with a specific wear schedule associated with one or more ophthalmic devices (e.g., contact lenses). The simple and inexpensive monitoring uses light to detect whether an ophthalmic device is present in a case (e.g., a contact lens case). When the ophthalmic device is not present in the case, then it can be assumed that the ophthalmic device is either being worn by the user or has been disposed of per life expectancy instructions.

In an aspect, the present disclosure includes a case (e.g., a contact lens case) comprising at least one storage well, a light source, a detector, and a microprocessor. The at least one storage well comprises a storage position for a contact lens. The light source is configured to generate light and direct the light into the at least one storage well. The detector is configured to detect reflected light from within the at least one storage well. The microprocessor is coupled to the light source and the detector and is configured to: activate the light source to send a pulse of the light toward the storage position of an ophthalmic device (e.g., a contact lens), and receive data related to the reflected light of the pulse of the light from the detector, wherein a presence or absence of the ophthalmic device in the storage position is determined based on the data related to the reflected light of the pulse of the light.

In another aspect, the present disclosure includes a method for automatically determining if an ophthalmic device (e.g., a contact lens) is stored in the case at a time. The method comprises activating, by a system comprising a processor, a light source to send a pulse of the light toward a storage position for a contact lens in a storage well of the case; receiving, by the system, an indication of reflected light from the storage position of the ophthalmic device in the case detected by a detector; and determining, by the system, a presence or an absence of the ophthalmic device within the storage position of the ophthalmic device in the case based on the reflected light.

In further aspect, the present disclosure includes a system comprising a case (e.g., a contact lens case) configured to store at least one ophthalmic device (e.g., at least one contact lens) within a storage well, an external device such as a mobile device, and the ophthalmic device to be stored in the storage well. The case comprises a light source, a detector, and a microprocessor. The light source is configured to generate light and direct the light into the at least one storage well. The detector is configured to detect reflected light from within the at least one storage well. The microprocessor is coupled to the light source and the detector and is configured to activate the light source to send a pulse of the light toward the storage position of the ophthalmic device, receive data related to the reflected light of the pulse of the light from the detector, and determine a presence or absence of the ophthalmic device based on the data related to the reflected light of the pulse of the light. The case can, optionally, transmit data to the external device for further analysis and determinations of user compliance with the contact lens wear schedule. The ophthalmic device can, optionally, include a reflective feature configured to reflect light when the ophthalmic device is positioned in the storage well.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 shows a top view and a side view cross section of an example case, shown as a contact lens case, having a single storage well;

FIG. 2 shows a top view and a side view cross section of an example case, shown as a contact lens case, having two storage wells;

FIG. 3 illustrate an example of the case of FIG. 1 detecting the presence or absence of an ophthalmic device;

FIG. 4 illustrates another example of the case of FIG. 1 detecting the presence or absence of the ophthalmic device;

FIG. 5 illustrates example instructions that can be executed by the microprocessor associated with the case of FIG. 1 or 2;

FIG. 6 is a flow diagram illustrating an example compliance check;

FIG. 7 is a process flow diagram illustrating a method for automatically determining the presence or absence of the ophthalmic device in the case; and

FIG. 8 is a process flow diagram illustrating a method for determining a user's compliance with a wear schedule for an ophthalmic device.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an,” and “the” can also include the plural forms, unless the context clearly indicates otherwise.

As used herein, the terms “comprises” and/or “comprising” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the terms “adherence” and “compliance” can be used interchangeably and refer to the degree to which a patient follows instructions (e.g., from a medical professional) to wear the one or more ophthalmic devices on a specific wear schedule. The patient can lack adherence to the wear schedule or be non-compliant with the wear schedule if the patient does not follow the instructions provided by the medical professional. In some cases a numerical quantification can be attached to describe how often a user is non-compliant/lacks adherence to the wear schedule (or conversely how often a user is compliant/adherent to the wear schedule). Worldwide, non-compliance is a major obstacle to the effective delivery of health care.

As used herein, the term “ophthalmic device” refers to a medical instrument used on or within at least a portion of a patient's eye for optometry or ophthalmology purposes (e.g., for diagnosis, surgery, vision correction, disorder treatment, or the like). One example of an ophthalmic device is a contact lens.

As used herein, the term “contact lens” refers to an ocular prosthetic device configured to be placed directly on the surface of the eye to correct vision, for cosmetic regions, and/or therapeutic reasons. Contact lenses can be categorized by primary function (e.g., vision correction, cosmetic, therapeutic, or the like), material (e.g., rigid, hard, or soft (hydrogel) lenses), wear schedule (how long a lens can be worn), and replacement schedule (how long before a lens needs to be discarded).

As used herein, the terms “case,” “contact lens case,” or the like refer to a storage device for one or more ophthalmic devices, such as contact lenses. As an example, the case can include at least one storage well for securely storing at least one ophthalmic device (e.g., contact lens) in a liquid or solution when the ophthalmic device is not being worn. The storage well can have a lid that screws on, snaps on, or otherwise attaches to the storage well to keep the ophthalmic device (and the liquid or solution) in the storage well. A case can have any shape and/or size and can include one or more materials such as plastics, metals, rubbers, or the like. In some instances, the case can help prevent bacteria from attaching to a contact lens.

As used herein, the term “storage well” refers to receptacle of the case that can have a volume, which can be configured to store an ophthalmic device and a liquid or solution for immersing the ophthalmic device. The receptacle can be covered with a removable lid fastened to an opening of the receptacle for secure storage when the ophthalmic device is not being worn (or when the case is not in use). A storage well can have any shape and/or size that can store an ophthalmic device and can be constructed of any one or more material that can facilitate the storage of the ophthalmic device and the liquid or solution.

As used herein, the terms “user”, “subject”, “wearer” and “patient” can be used interchangeably and refer to any warm-blooded organism, but generally refers to a human that can use the ophthalmic device and/or the case.

### II. Overview

It is important that users of ophthalmic devices, such as contact lenses, adhere to a wear schedule, especially when using drug delivery contact lenses. However, many users can be lax and forgetful about following a specific schedule for wearing their one or more ophthalmic devices. As an example, in order for drug delivery contact lenses to be effective for treatment or symptom relief, the user must be wearing the lenses as instructed and during any drug delivery period to receive the therapeutic. A simple and cost-effective way to track user compliance with a wear schedule is needed to correctly determine whether a treatment is or is not working or whether a user is simply not complying with wear instructions.

Described herein are simple and inexpensive ways to monitor if one or more ophthalmic devices are placed within a case to determine user compliance with a wear schedule. An assumption is made that if the one or more ophthalmic devices are not in the case, then it is either in the eye or has been disposed of per life expectancy instructions. A case can include at least one LED and a light detector to monitor reflectance of the light emitted from the at least one LED to monitor whether the one or more ophthalmic device is present in the case. In one example, the one or more ophthalmic device for use with the case can include a small reflective feature, in which case greater light reflectance can indicate the one or more ophthalmic devices are not being worn at a given time. In another example, the case itself can further include at least one reflective feature that is at least partially blocked from the at least one LED and the light detector when the one or more ophthalmic device is present in the case, as less light reflectance can indicate the contact lens is not being worn at a given time.

### III. Systems

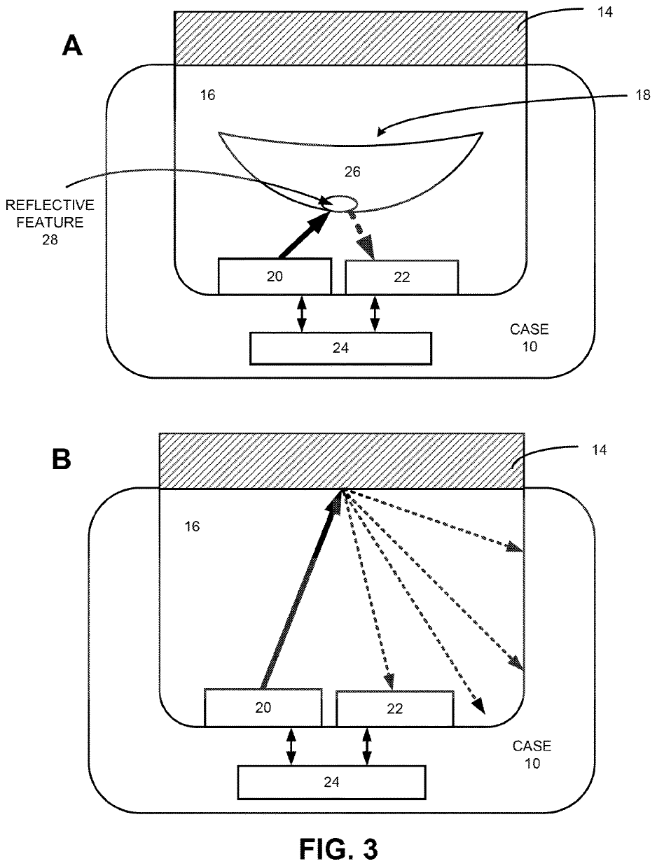

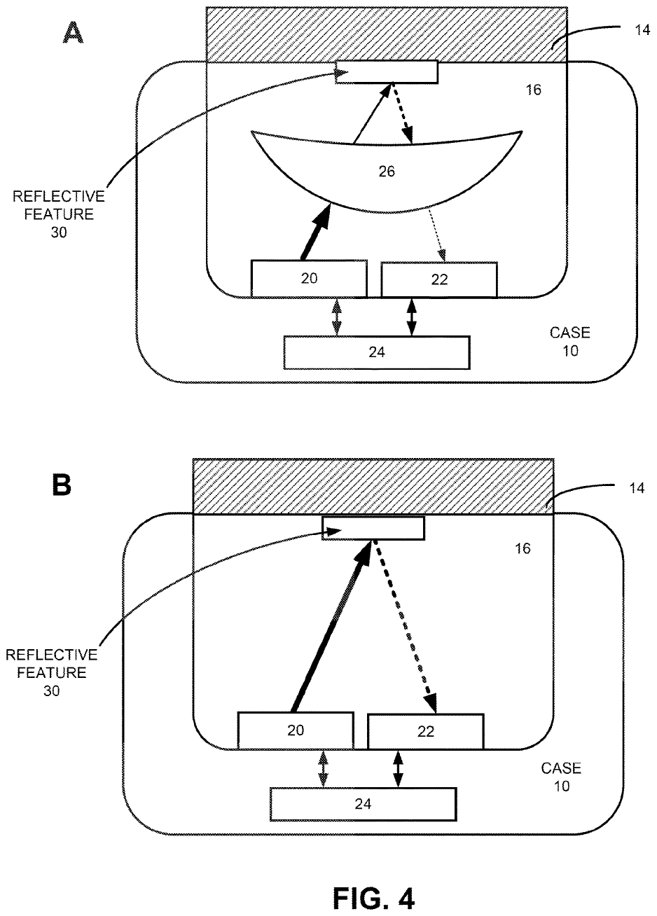

One aspect of the present disclosure relates to a simple and cost-effective way to track user compliance with a wear schedule of an ophthalmic device. A case can include an optical system, which can be used to determine the presence and or absence of one or more ophthalmic devices within the case at a given time. The case will be described as a contact lens case and the one or more ophthalmic devices will be described as one or more contact lenses throughout (notably with regard to FIGS. 3 and 4), but it should be understood that any ophthalmic device and case for storage of said ophthalmic device when not in use is contemplated. Additionally, it should be understood that the example case shown in the figures, can be sized and shaped in any manner to securely store one or more ophthalmic devices.

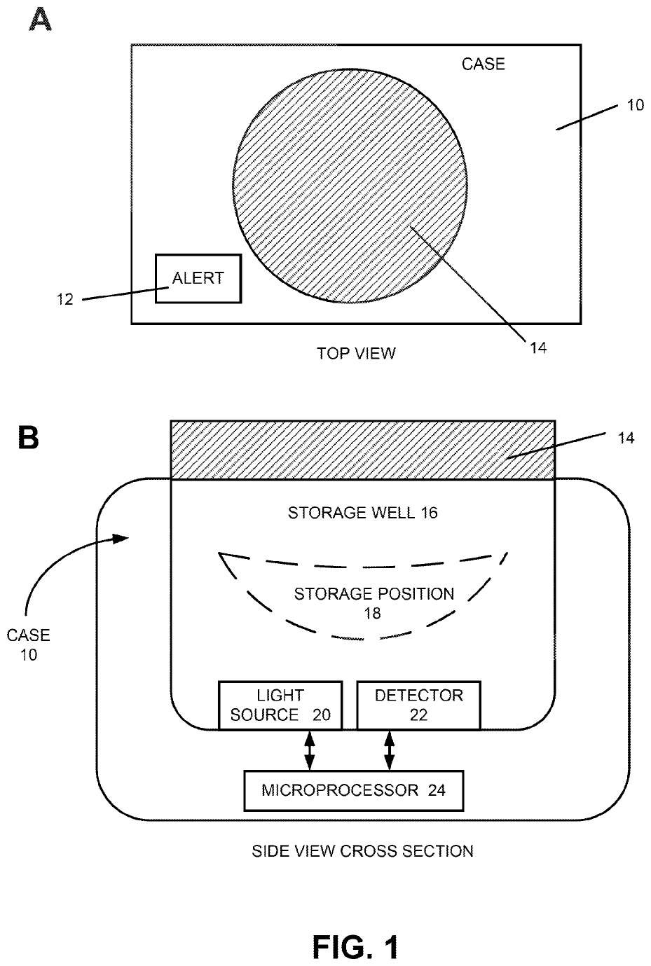

FIG. 1, element A, shows a top view of an example case 10 containing a single storage well (which may be covered by a removeable lid 14) and FIG. 1, element B, shows a side view cross section of the same example case 10 additionally showing the single storage well 16 and an associated storage position 18 for the ophthalmic device. In FIG. 1, element A, the top view of the case 10 shows an alert mechanism 12 that can be attached to a portion of case (illustrated at a location on the top surface of the case, but may be located in any position on the case 10 including at a different position of the top, at any location on one of the sides, and/or at any location on the bottom, also may be at least partially internal to the case) and the removable lid 14 that can be securely fastened to a storage well (storage well 16 shown in element B).

The alert mechanism 12 can alert a user, for example, if the user is not complying with a wear schedule or if a schedule wear time is upcoming (e.g., 10 minutes, 5 minutes, 1 minute, or the like before). As previously noted, the alert mechanism 12 is shown on the top surface of the case 10 but can be positioned on any portion of the case (interior or exterior). The alert mechanism 12 can be, for example, an LED, a visual display, a speaker, a motor, or the like that can provide at least one of a visual, audio, or haptic alert to the user.

Referring now to FIG. 1, element B, the side view cross section of the case 10 shows that the case can include at least one storage well (shown as storage well 16) that can include a storage position 18 of the ophthalmic device. It should be noted that the removable lid 14 can be detached from the storage well 18 by a user in order to place an ophthalmic device within at the storage position 18 or take an ophthalmic device out of the storage (so that the storage position 18 is empty). The case 10 can include the optical system, which can be used to determine the presence and or absence of one or more ophthalmic devices within the case at a given time, and includes a light source 20 and a detector 22. The light source 20 and/or the detector 22 can be in communication (wired and/or wireless) with a microprocessor 24. The light source 20 and the detector 22 can both be positioned at least partially within an interior of the storage well 16 of the case 10. For example, the storage well 16 can have an interior having a volume to hold one ophthalmic device (e.g., a contact lens) (e.g., sized to store the ophthalmic device and a liquid or solution to immerse the ophthalmic device) and the interior can include the light source 20 and the detector 22. The light source 20 can generate light and direct the light into the at least one storage well 16 in the direction of the storage position 18. The light source 20 can be a single light source (as shown) or a plurality of light sources positioned in a ring (or any other perimeter shape) around the storage position 18. The light source 20 can be a light emitting diode (LED) that can emit a given wavelength or range of wavelengths of light. For example, the wavelength(s) can be ultraviolet, and/or infrared. In another example, the wavelengths can be additionally and/or alternatively in the visible range. The detector 22 can be positioned to detect, and can detect, at least a portion of the reflected light from within the storage well 16 (and/or from the underside of the removable lid 14) when the light source 20 emits light. The detector 22 can detect a property of the reflected light (e.g., an amount, an intensity, a reflected wavelength, or the like). The detector 22 can be for example, a photosensor and/or a photodetector. The detector 22 can be positioned next to the light source 20, for example the detector can be adjacent to the light source or a distance away from the light source. The distance between the light source 20 and the detector 22 can be based on the known angle of reflectance of the light emitted by the light source. The light source 20 and the detector 22 are shown positioned at the bottom of the storage well 16 but it should be understood the light source 20 and the detector 22 can be positioned at any location in the storage well such that the detector can receive/detect reflected light when the light source 20 emits a light.

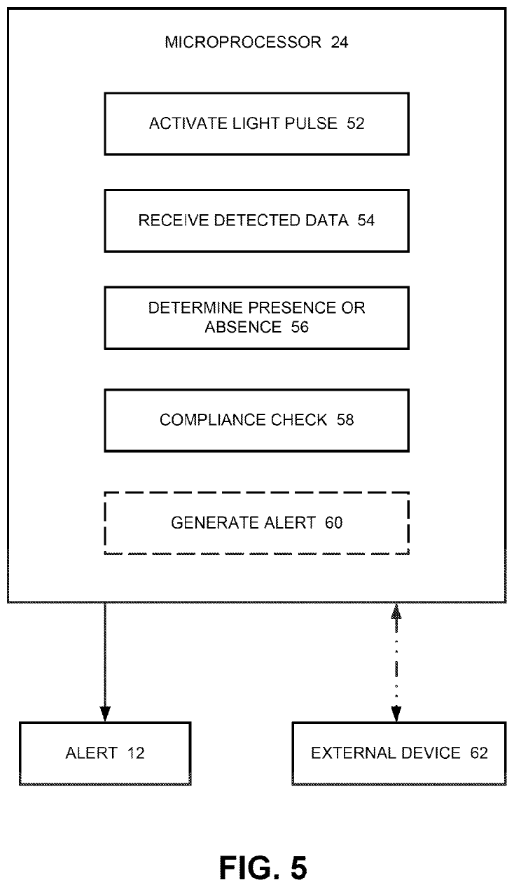

The microprocessor 24 can activate the light source 20 to send a pulse of light toward the storage position 18 of the ophthalmic device and can receive data related to the reflected light of the pulse of the light (or lack thereof) from the detector 22. The presence or absence of the ophthalmic device in the storage position 18 in the storage well 16 can be determined based on the data related to the reflected light of the pulse of the light. The determination can be made by the microprocessor 24 and/or the microprocessor 24 can be in communication (wired and/or wireless) with an external device (not shown) that includes at least a processor and a memory (e.g., a smartphone, a computer, or the like) that can make the determination. The microprocessor 24 can also be in communication (wired and/or wireless) with the alert mechanism 12. Other functions of the microprocessor 24 are described in further detail with respect to FIG. 5 below.

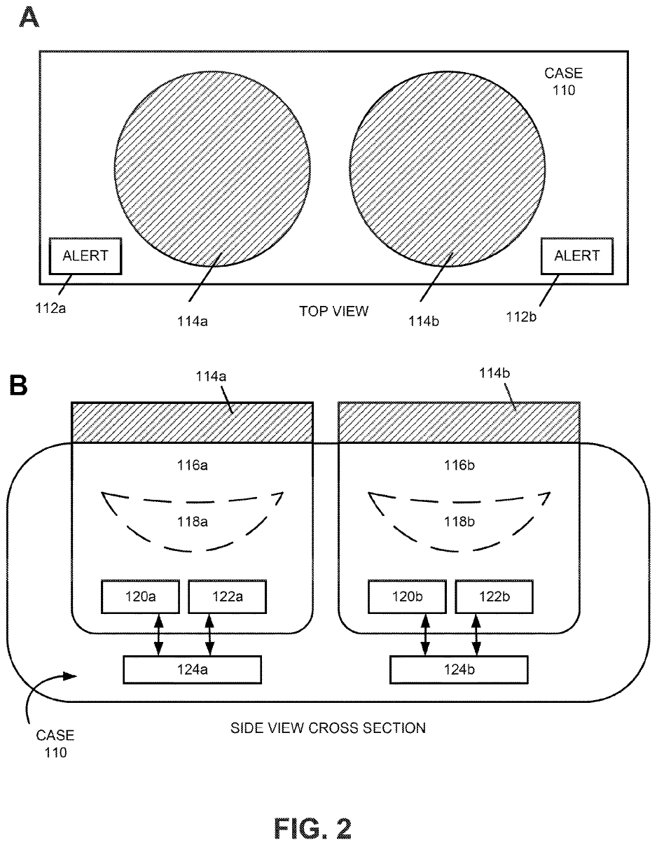

FIG. 2 shows another example case 110 (e.g., contact lens case) that includes two storage wells 116a and b for securely storing two ophthalmic devices (one per storage well). FIG. 2, Element A, shows a top view of the example case 110 and FIG. 2, Element B, shows a side view cross section of the case. The case 110 for storage of two ophthalmic device can include two alert mechanisms 112a and b and each alert mechanism can be for a particular storage well 116a and b (e.g., in communication with a particular microprocessor 124a and b). The storage wells 116a and b can each have a separate removable lid 114a and b, respectively, and may be labeled for storing an ophthalmic device for a left eye and a right eye, respectively. Each of the two storage wells 116a and b can include a storage position 118a and b for one ophthalmic device and at least a portion of each of a light source 120a and b and a detector 122a and b. As shown in FIG. 2, Element B, a first microprocessor 124a can be in communication with the light source 120a, the detector 122a, and the alert mechanism 112a of the first storage well 116a and a second microprocessor 124b can be in communication with the second microprocessor 124b can be in communication with the light source 120b, the detector 122b, and the alert mechanism 112b of the second storage well 116b. While not shown, it should be understood that a single microprocessor may take the place of the first and second microprocessors 124a and b. The presence or absence of an ophthalmic device in each of the storage wells 116a and b can be determined independently (by a microprocessor 124a and/or b; or an associated external device) based on data from the detector 122a and b related to each of the storage wells, respectively.

FIGS. 3 and 4 show different example configurations and use cases of the single storage well case 10 with relation to storing a contact lens 26 (an example ophthalmic device), but it should be understood that this description can apply to the two-storage well case 110 as well and any type of ophthalmic device. In FIG. 3, the contact lens 26 (the example ophthalmic device) includes a reflective feature 28 and, alternatively, in FIG. 4, the storage well 16 of the case 10 can further include a reflective feature 30. The reflective feature 28 or 30 can be reflective to light. For example, ultraviolet light wavelength ranges, visible light wavelength ranges, and/or infrared light wavelength ranges. In the situation of FIG. 3, the case 10 and the contact lens 26 including the reflective feature 28 can be a system.

FIG. 3, Element A, shows an example where the contact lens 26 (the example ophthalmic device) including the reflective feature 28 can be positioned in the case 10 (e.g., in the storage position 18 of the storage well 16). The storage well 16 can include a fluid such that the contact lens 26 can be immersed in the fluid (e.g., a liquid or solution) (not shown) that can be designed for storage and/or anti-bacterial purposes. It should be noted that although the reflective feature 28 is illustrated as being in the center of the contact lens 26, this is merely for ease of illustration. The reflective feature 28 can be positioned at any position on the contact lens 26. As an example, the reflective feature 28 can be at a location where the reflective feature 28 would not affect vision.

In FIG. 3, a light pulse (arrow) can be emitted from the light source 20 towards the storage position 18. The microprocessor 25 coupled to the light source 20 can activate the light source to send the pulse of the light towards the storage position (e.g., storage position 18) of the contact lens 26. In FIG. 3, Element A, the contact lens 26 is in the storage position 18 inside the storage well 16 and the reflective feature 28 can reflect at least a portion of the light of the light pulse. The reflected light (dotted arrow) can be directed at least substantially towards the detector 22. In FIG. 3, Element B, the contact lens 26 is not inside the storage well 16, and is presumed to be in use (e.g., in/on the user's eye) or disposed of per lifetime expiration. Because the ophthalmic device 26 is not in the storage well 16 the light pulse (arrow) emitted from the light source 20 travels further, to the underside of the removable lid 14 as an example, where the reflected light (skinnier dotted arrow) is less focused (e.g., is dispersed because the material is less reflective than the reflective feature). The detector 22 can detect the reflected light, where more reflected light (or reflected light of a greater intensity) can be detected when the contact lens 26 including the reflective feature 28 is in the storage well 16 (as shown in Element A with the larger dotted arrow) than when the contact lens is not in the storage well (as shown in Element B with the unfocused and smaller dotted arrows).

The microprocessor 24 can receive data related to the reflected light of the pulse of the light from the detector 22 and then can determine a presence of absence of the contact lens 26 based on the data related to the reflected light of the pulse of the light. The presence or absence of the contact lens 26 can be based on the reflective feature 28 of the at least one contact lens (e.g., because more light or more focused light can be reflected towards the detector 22 by the reflective feature than the underside of the removable lid 14 or the interior of the storage well 16). For example, the presence or absence of the contact lens 26 in the storage well 16 can be determined based on an intensity of the reflected light, wherein the intensity of the reflected light is greater when the contact lens is present in the storage well because the reflected light reflects off the reflective feature 28 of the contact lens with a greater intensity than off the interior of the storage well. The user of the contact lens 26 can be determined (e.g., by the microprocessor 24 and/or an external device in communication with microprocessor) to be compliant with wear instructions for the contact lens (e.g., stored in a memory of the microprocessor and/or the external device) if the contact lens is determined to be absent from the case 10 for a period of time that corresponds to a period of time the wear instructions indicate the contact lens should be worn.

It should be understood that the contact lens 26 of FIG. 3, Element A, can be any type of ophthalmic device. The reflective feature 28 of the contact lens 26 can be any reflective material that can reflect at least one of ultraviolet and/or infrared wavelength ranges. Alternatively, and/or additionally, the reflective material can reflect one or more wavelengths in the visible wavelength range. The reflective feature 28 can be positioned in and/or on the contact lens 26 outside the field of view of the user when the contact lens is in use or within the field of view of the user when the contact lens is in use. As previously noted, the reflective feature 28 can be any size and/or shape such that it fits in/on the contact lens 26 and but does not disrupt a user's view. If the reflective feature 28 is positioned in the field of view of the user, then the reflective feature can be sized small enough and near enough to a pupil plane of the user such that the reflective feature does not disrupt the user's vision (e.g., is not noticeable to the vision of the user). For example, the reflective feature can have a diameter of 1000 microns or less, 750 microns or less, 500 microns or less, 250 microns or less, or the like. In one example, the reflective feature 28 can be encapsulated in a body of the contact lens 26. In another example, the reflective feature 28 can be a material of at least a portion of the body of the contact lens 26.

As an example, if the contact lens 26 is an active drug dispensing contact lens, then the reflective feature 28 can be, for example, one or more metallic electrode covers (e.g., a thin film gold electrode) of one or more drug dispensing wells within the active drug dispensing contact lens. The light source 20 may be a plurality of light sources in a ring shape around the interior of the storage well 16 and the detector 22 may be one or more detectors positioned to receive reflected light from a specific light source of the plurality of light sources. The microprocessor 24 can active each of the light sources to emit a pulse of light towards the areas the one or more metallic electrode covers would be and then receive data from each of the detectors related to the individual reflected light from the one or more metallic electrode covers to determine the presence or absence of the contact lens 26 in the case 10. The microprocessor 24 can additionally, and/or alternatively, determine the presence or absence of each of the one or more metallic electrode covers based on a property of the reflected light detected by the detector 22. In this example, the light source 20 may be a plurality of light sources in a ring shape and the detector 22 may be one or more detectors.

Referring now to FIG. 4, illustrated is an example where the reflective feature 30 can be positioned on the inside of the storage well 16 (shown positioned on the underside of the removable lid 14) of the case 10, rather than on and/or in the contact lens 26. The reflective feature 30 is shown as rectangular but can be any size and/or shape. The reflective feature 30 can be any material that can reflect at least one of light in the ultraviolet wavelength range or the infrared wavelength range. The reflective feature 30 can be positioned anywhere in the storage well 16 such that when the contact lens 26 is in the storage position (e.g., storage position 18) in the storage well 16 the ophthalmic device is between the reflective feature and at least one of the light source 20 and the detector 22. The light source 20, the detector 22, and the microprocessor 24 can work as previously described, with the exception of how the microprocessor determines presence and/or absence of the contact lens 26 in the storage well 16 of the case 10.

FIG. 4, Element A, shows an example where the contact lens 26 is positioned in the storage well 16 (e.g., in the storage position 18) and FIG. 4, Element B, shows the example where the contact lens is absent from the storage well 16 (e.g., in/on the user's eye or disposed of per lifetime expiration instructions). In FIG. 4, Element A, the contact lens 26 can block and/or scatter at least a portion of the light pulse emitted from the light source 20 (when activated by the microprocessor 24) such that less than all the light pulse is reflected by the reflective feature 30 and then the contact lens may block and/or scatter a portion of the reflected light before the remainder of the reflected light reaches the detector 22 (as shown by the arrow becoming smaller and the line becoming dotted). It should be understood that while a remainder of reflected light (skinny dotted arrow) is shown reaching the detector 22, in some situations the detector may detect no reflected light when the contact lens 26 is in the storage well 16.

In FIG. 4, Element B, the contact lens 26 is absent from the storage well 16. The light source 20 can emit the pulse of light (shown as arrow) (when activated by the microprocessor 24) towards the storage area (e.g., storage area 18) and the reflective feature 30. Because the contact lens 26 is absent substantially all or all of the light can reach the reflective feature 30 and the reflective feature can reflect substantially all or all of the light (shown as dotted line arrow, but same size) towards the detector 22. The detector 22 can detect the reflected light. More light and/or a greater intensity of light can be detected by the detector 22 when the contact lens 26 is not present in the storage well 16. The microprocessor 24 can receive the data related to the reflected light of the pulse of the light from the detector 22 and then a presence or absence of the ophthalmic device in the storage position is determined based on the data related to the reflected light of the pulse of the light. In this case, the contact lens 26 can be determined to be absent if an intensity of light above a given threshold is detected or present if an intensity of light below a given threshold is detected.

Referring now to FIG. 5, functions of the microprocessor 24 are described in further detail. The microprocessor 24 functions described herein can be completed by one or more microprocessors (as shown in FIG. 2). The microprocessor 24 can include at least a temporary memory and can execute one or more instructions stored in the at least the temporary memory. The microprocessor 24 can be coupled to (e.g., in wired and/or wireless communication) with the alert mechanism 12. The microprocessor 24 may also be coupled to an external device 62 (or more than one external device) by a wireless communication connection. The external device 62 can be a device operated by the user and/or a device operated by a medical professional associated with the prescription/wear instructions for the ophthalmic device. In some instances the microprocessor 24 can receive information from the external device 62, such as the times and dates of the wear schedule of the ophthalmic device, parameters for light emittance (e.g., wavelengths, pulse number, intensities, length of pulses, or the like), detection thresholds, or the like, and can send information to the external device such as,

The microprocessor 24 can include functionalities for controlling the light source(s) and the detector(s) of the ophthalmic device case(s) described above. The microprocessor 24 can activate light pulse 52 by activating the light source(s) to emit a light pulse having desired parameters (e.g., pulse length, intensity, time of emission, or the like). The activation can be automatic (e.g., timed based on information from the wear instructions to check if the ophthalmic device is or is not in the case) and/or manual (e.g., triggered by the associated medical professional via an external device 62 to spot check if the user is compliant with wear instructions).

The activation can include activating the light source to send pulses of light toward the storage position of the ophthalmic device in the storage well at a plurality of time points in a time cycle (e.g., every 10 seconds, 30 seconds, 1 minute, or the like for 5 minutes, 10 minutes, 30 minutes, an hour, a day, or the like). In response to the detector detecting reflected light, the microprocessor 24 can received detected data 54 from the detector. The detected data can be data related to the reflected light of the pulse of the light and can include at least one of an amount, an intensity, one or more wavelengths, or the like of the reflected light. The receiving detect data 54 can include receiving the data related to each of the reflected light of the pulses of light emitted for the plurality of time points in the time cycle from the detector.

The microprocessor 24 can determine presence or absence 56 of the ophthalmic device in the storage well (or of each ophthalmic device in each storage well of a case having multiple storage wells). In some instance this determination may be made by a processor of the external device 62 of the user in communication with the microprocessor. The determination can be made, for example, based on the intensity of the reflected light detected by the detector. For example, if the reflective feature is in and/or on the ophthalmic device and an intensity of reflected light is greater than a threshold amount and/or range (stored in memory), then the microprocessor 24 can determine the ophthalmic device is within the storage well.

When the reflected light is less than a threshold amount and/or range, then the microprocessor 24 can determine the ophthalmic device is absent. Alternatively, if the reflective feature is part of the storage well (including the underside of the removable lid) and an intensity of reflected light is greater than the threshold amount and/or range (stored in memory), then the microprocessor 24 can determine the ophthalmic device is not within the storage well. When the reflected light is less than the threshold amount and/or range, then the microprocessor 24 can determine the ophthalmic device is present.

After determining the presence and/or absence of the ophthalmic device in the case (e.g., in the storage well), the microprocessor 24 can compliance check 58 to determine if the user is complying with wear instructions (stored in memory) for the given time period. The compliance check 58 can include determining an amount of time the ophthalmic device is present or absent from the storage well for the time cycle, where the determination is based on the data related to the reflected light of the pulse of the light from the detector for each of the plurality of time points in the time cycle. The amount of time the ophthalmic device is present and/or absent from the storage well can be indicative of an amount of time the ophthalmic device is worn by the user and/or a degree to which the user is compliant with a prescription. The microprocessor can generate an alert 60 if the user is found to be non-compliant and/or is close to a time when they would be non-compliant and the ophthalmic device is still present in the case. The alert can be sent to the alert mechanism 12 on the case (e.g., one or more of an LED, a visual display, a speaker, a haptic motor, or the like) to visually, audibly, and/or haptically notify the user of the alert. The alert can also and/or alternatively be sent to the external device 62 for visually, audible, or haptic notification (e.g., as a pop-up notification on a smart phone or the like). A separate alert can additionally and/or alternatively be sent to the medical professional (e.g., via a different external device 62 associated with the medical professional) if the user is non-compliant (e.g., based on a specific time and/or if the amount of time the ophthalmic device is absent from the case is less than a predetermined amount of time. The compliance check 58 and generate alert 60 may also and/or alternatively be completed a processor of the external device 62.

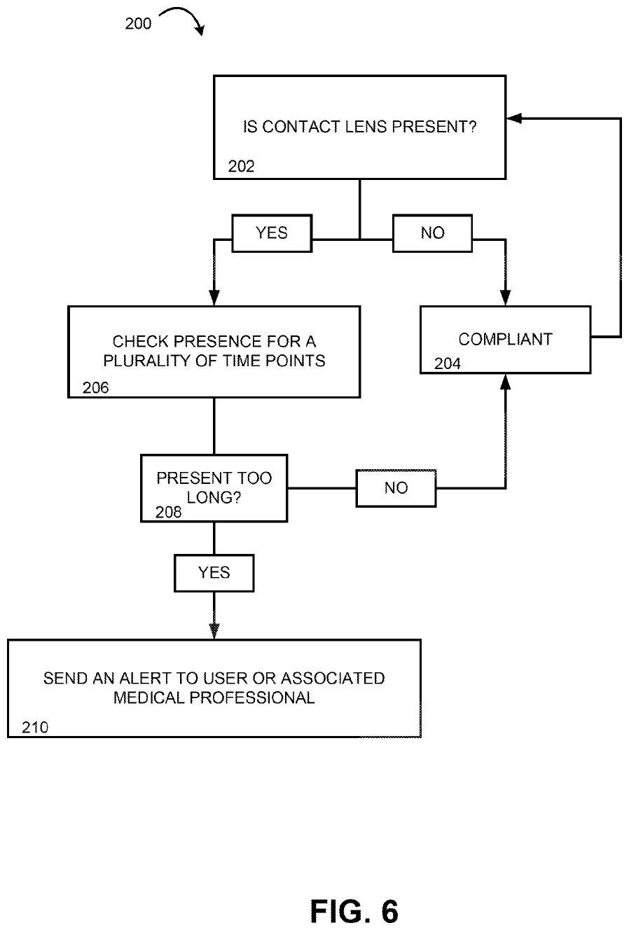

FIG. 6 shows a flow diagram of an example compliance check 200. The flow diagram illustrates example logic for determining a presence/absence of a contact lens (but can be understood for any type of ophthalmic device) that can be run by the microprocessor and/or a processor of the external device. At 202, the query is the contact lens present is asked, which triggers the activation of the light source and the detection by the detector. If the answer is the contact lens is not present in the case (e.g., based on determination 56 of FIG. 5), then the user is found to be compliant for that time. The query can then be asked again at a later time. If the answer is the contact lens is present in the case, then the microprocessor and/or processor can check the presence of the contact lens in the case for a plurality of time points 206 and determine if the contact lens has been present for too long 208 (based on the wear instructions). If the contact lens has not been present in the case for too long, then the user is determined to be compliant for the time. The entire query can then be asked again at a later time. If the contact lens has been present in the case for too long, then the microprocessor and/or the processor can generate and send an alert to the user and/or the associated medical professional that the user is not compliant for the time period.

### IV. Methods

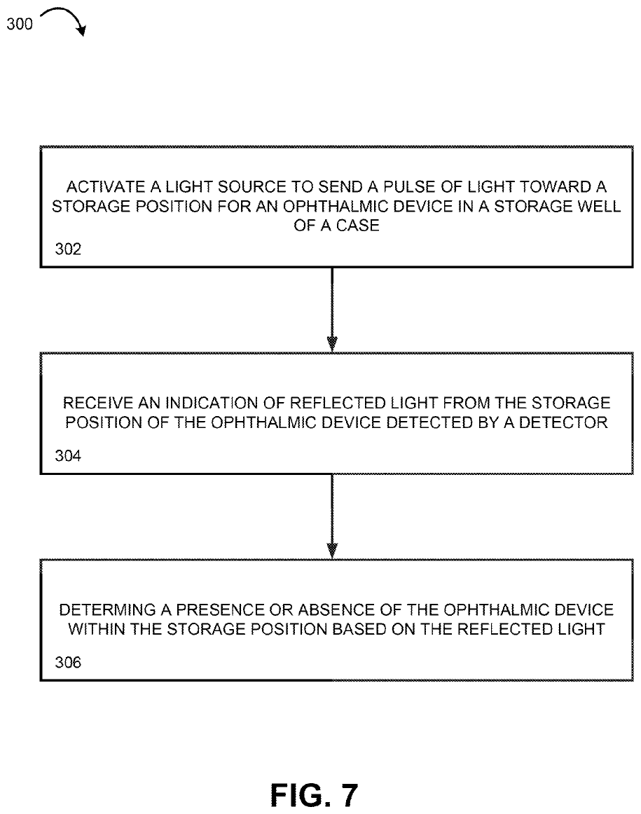

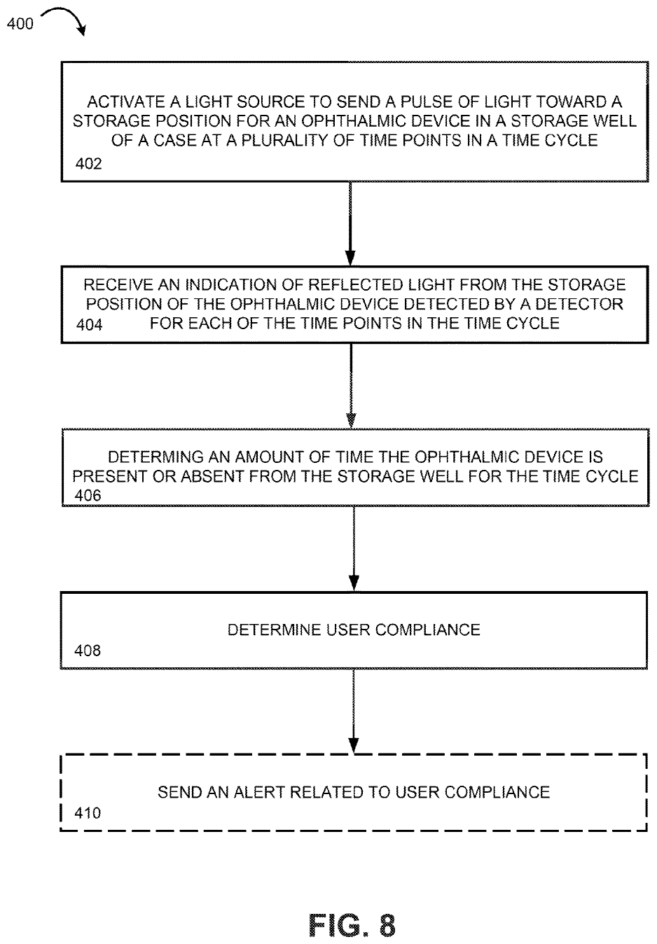

Another aspect of the present disclosure can include methods 300 and 400 (FIGS. 7 and 8) for automatically determining the presence or absence of an ophthalmic device in the case and determining a user's compliance with a wear schedule for the ophthalmic device, respectively. The methods 300 and 400 can be executed using, at least, the case 10 or 110 and the contact lens 26 (or any ophthalmic device) described above with respect to FIGS. 3-4. Indeed, any of FIGS. 1-6 can be used in the execution of the methods 300 and 400.

The methods 300 and 400 are illustrated as process flow diagrams with flowchart illustrations. For purposes of simplicity, the methods 300 and 400 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 300 and 400.

Referring now to FIG. 7, illustrated is a method 300 for automatically determining the presence or absence of the ophthalmic device in the case. At 302, a system, including the case for the ophthalmic device (e.g., case 10 or 110) and a processor (e.g., microprocessor 24 and/or the processor of the external device 62), can activate a light source (e.g., light source 20 of case 10 or one of light sources 20a or 20b of case 110) to send a pulse of the light toward a storage position for an ophthalmic device in a storage well of the case. At 304, an indication of reflected light from the storage position of the ophthalmic device in the case detected by a detector can be received by the system (e.g., the microprocessor and/or processor). The indication can be data transmitted from the detector to the microprocessor/detector that is related to at least one of the intensity, amount, length of time, one or more wavelengths of light, or the like of the reflected light. At 306 a presence or an absence of the ophthalmic device within the storage position of the ophthalmic device in the case can be determined by the system (e.g., the microprocessor and/or processor) based on the reflected light. The presence or absence of the ophthalmic device can be determined based on if the intensity/amount of the reflective light is greater than or less than when no ophthalmic device is in the case.

Referring now to FIG. 8, illustrated is a method 400 for determining a user's compliance with a wear schedule (e.g., wear instructions) for an ophthalmic device, such as a drug dispensing contact lens. At 402, the light source (e.g., light source 20) can be activated (e.g., by the microprocessor 24) to send the pulse of the light toward the storage position of the ophthalmic device in the storage well at a plurality of time points in a time cycle. At 404, the data related to each of the reflect light of the pulse of the light from the detector (e.g., detector 22) for each of the plurality of time points can be received by the system (e.g., by the microprocessor 24). At 406, an amount of time the ophthalmic device is present or absent from the storage well for the time cycle can be determined by the system (e.g., by the microprocessor 24) based the data related to the reflected light of the pulse of the light from the detector for each of the plurality of time points in the time cycle. At 408, user compliance can be determined by the system (e.g., by the microprocessor 24). The amount of time the ophthalmic device is present or absent from the storage well can be indicative of an amount of time the ophthalmic device is worn and/or a user is compliant with a prescription (e.g., wear instructions). The user can be determined to be compliant if the ophthalmic device is absent for a certain amount of time, for a specific time, or the like according to when the wear instructions indicate the ophthalmic device should be in use. Optionally, at 410, an alert (e.g., visual, audible, and/or haptic) can be sent to the user and/or an associated medical professional related to the user's compliance (e.g., if the user is not compliant, if the user is not compliant for a certain number of times, if the user is about to be non-compliant, or the like).

From the above description, those skilled in the art will perceive improvements, changes, and modifications. Such improvements, changes and modifications are within the skill of one in the art and are intended to be covered by the appended claims.

The following is claimed:

1. A case configured for ophthalmic device storage, the case comprising:
at least one storage well comprising a storage position for the ophthalmic device;
a light source configured to generate light and direct the light into the at least one storage well;
a detector configured to detect reflected light from within the at least one storage well; and
a microprocessor coupled to the light source and the detector and configured to:
activate the light source to send a pulse of the light toward the storage position of the ophthalmic device; and
receive data related to the reflected light of the pulse of the light from the detector,
wherein a presence or absence of the ophthalmic device in the storage position is determined based on the data related to the reflected light of the pulse of the light.

2. The case of claim 1, further comprising at least two storage wells, each having storage position for one ophthalmic device, the light source, and the detector, wherein the presence or absence of each ophthalmic device is determined based on data from the detector related to the storage well.

3. The case of claim 1, wherein the microprocessor is configured to activate the light source to send the pulse of the light toward the storage position of the ophthalmic device in the storage well at a plurality of time points in a time cycle and to receive the data related to each of the reflect light of the pulse of the light from the detector for each of the plurality of time points.

4. The case of claim 3, wherein an amount of time the ophthalmic device is present or absent from the storage well for the time cycle is determined based the data related to the reflected light of the pulse of the light from the detector for each of the plurality of time points in the time cycle,

5. The case of claim 4, wherein when the amount of time the ophthalmic device is present or absent from the storage well is indicative of an amount of time the ophthalmic device is worn and/or a user's compliance with a prescription.

6. The case of claim 1, wherein the microprocessor is configured to determine an amount of time the ophthalmic device is absent from the case based on the amount of time the ophthalmic device is present or absent from the storage well, and if the amount of time the ophthalmic device is absent from the case is less than a predetermined amount of time, the microprocessor is further configured to send an alert to the user or a medical professional.

7. The case of claim 1, wherein each of the at least one storage well has an interior configured to hold one ophthalmic device and comprises the light source and the detector.

8. The case of claim 1, wherein the light source is a plurality of light sources positioned in a ring around the storage position and the detector is positioned and configured to receive the reflected light.

9. The case of claim 1, wherein the microprocessor is further configured to determine the presence or absence of a cover of a drug delivery well based on a property of the reflected light detected by the detector.

10. The case of claim 1, wherein the of the data related to the reflected light of the pulse of the light comprises an intensity of the reflected light.

11. The case of claim 1, wherein the light source is a light emitting diode configured to emit a wavelength of light and wherein the wavelength of light is ultraviolet or infrared.

12. The case of claim 1, wherein the ophthalmic device or the storage well of the case comprises a reflective feature configured to reflect in ultraviolet light wavelengths or infrared light wavelengths.

13. The case of claim 1, wherein the detector is a photosensor and/or a photodetector.

14. The case of claim 1, wherein the detector is positioned next to the light source.

15. A method comprising:
activating, by a system comprising a processor, a light source to send a pulse of the light toward a storage position for an ophthalmic device in a storage well of a case;
receiving, by the system, an indication of reflected light from the storage position of the ophthalmic device in the case detected by a detector; and
determining, by the system, a presence or an absence of the ophthalmic device within the storage position of the ophthalmic device in the case based on the reflected light.

16. The method of claim 15, wherein the presence or absence of the ophthalmic device is determined based on if the intensity/amount of the reflective light is greater than or less than when no ophthalmic device is in the case.

17. The method of claim 15, wherein activating the light source and receiving the data further comprises:
activating the light source to send the pulse of the light toward the storage position of the ophthalmic device in the storage well at a plurality of time points in a time cycle; and
receiving the data related to each of the reflect light of the pulse of the light from the detector for each of the plurality of time points.

18. The method of claim 17, further comprising determining an amount of time the ophthalmic device is present or absent from the storage well for the time cycle based the data related to the reflected light of the pulse of the light from the detector for each of the plurality of time points in the time cycle.

19. The method of claim 18, wherein when the amount of time the ophthalmic device is present or absent from the storage well is indicative of an amount of time the ophthalmic device is worn and/or a user's compliance with a prescription.

20. A system comprising:
a case configured to store an ophthalmic device within a storage well, the case comprising:
a light source configured to generate light and direct the light into the at least one storage well; and
a detector configured to detect reflected light from within the storage well; and
a microprocessor coupled to the light source and the detector and configured to:
activate the light source to send a pulse of the light toward the storage position of the ophthalmic device;
receive data related to the reflected light of the pulse of the light from the detector; and
determine a presence or absence of the ophthalmic device based on the data related to the reflected light of the pulse of the light.

21. The system of claim 20, further comprising the ophthalmic device configured to be stored within the storage well.

22. The system of claim 21, wherein the presence or absence of the ophthalmic device is based on a reflective feature of the ophthalmic device.

23. The system of claim 22, wherein the reflective feature is positioned in the field of view of a user wearing the ophthalmic device.

24. The system of claim 22, wherein the reflective feature has a diameter of 500 microns or less.

25. The system of claim 22, wherein the reflective feature is near enough a pupil plane such that it is not noticeable to the vision of the user.

26. The system of claim 22, wherein the reflective feature is encapsulated in the ophthalmic device.

27. The system of claim 22, wherein the reflective feature is a material of the body of the ophthalmic device.

28. The system of claim 22, wherein the reflective feature is configured to reflect ultraviolet or infrared wavelengths.

29. The system of claim 20, wherein the presence or absence of the ophthalmic device in the storage well is determined based on an intensity of the reflected light, wherein the intensity of the reflected light is greater when the ophthalmic device is present in the storage well because the reflected light reflects off the reflective feature of the ophthalmic device with a greater intensity than off the interior of the storage well.

30. The system of claim 20, wherein a user of the ophthalmic device is determined to be compliant with wear instructions for the ophthalmic device if the ophthalmic device is determined to be absent from the case for a period of time.
